(19) United States
(12) Patent Application Publication
(10) Pub. No.: US 2025/0162024 A1
(43) Pub. Date: May 22, 2025

(54) SLIDING NOZZLE APPARATUS

(71) Applicant: KROSAKIHARIMA CORPORATION, Fukuoka (JP)

(72) Inventors: Toshihiro IMAHASE, Fukuoka (JP); Akira OTSUKA, Fukuoka (JP); Takeshi FUJIMOTO, Fukuoka (JP)

(73) Assignee: KROSAKIHARIMA CORPORATION, Fukuoka (JP)

(21) Appl. No.: 18/832,600

(22) PCT Filed: Jan. 12, 2023
(86) PCT No.: PCT/JP2023/000627

§ 371 Date: Jul. 24, 2024

(30) Foreign Application Priority Data
Jan. 26, 2022 (JP) 2022-010446

(51) Int. Cl. B22D 41/24; B22D 41/34; B22D 41/40

(52) U.S. Cl. CPC B22D 41/24; B22D 41/34; B22D 41/40

(57) ABSTRACT

A sliding nozzle apparatus in which components constituting the sliding nozzle apparatus are less likely to be damaged even when a surface pressure is loaded with no refractory plate mounted. The sliding nozzle apparatus comprises a fixed metal frame and a sliding metal frame which is slidably provided with respect to the fixed metal frame. The sliding metal frame is movable between a first position where, in a state where two refractory plates are mounted, respectively, in a plate-receiving recess of the fixed metal frame and a plate-receiving recess of the sliding metal frame, a surface pressure can be loaded between the two refractory plates, and a second position where, in a state where no refractory plate is mounted to either plate-receiving recess, a surface pressure can be loaded between the fixed metal frame and the sliding metal frame.

### TECHNICAL FIELD

The present invention relates to a sliding nozzle apparatus which is attached to the bottom of a molten metal vessel such as a ladle, to adjust the amount of molten steel flowing out of the molten metal vessel.

### BACKGROUND ART

There has been known a sliding nozzle apparatus of a type configured to adjust the amount of molten steel flowing out of a molten metal vessel by sliding a sliding metal frame with respect to a fixed metal frame under the condition that a surface pressure is loaded between a refractory plate mounted to the fixed metal frame and a refractory plate mounted to the sliding metal frame in a state in which the two refractory plates are opposed to each other, as disclosed in, e.g., Patent Document 1.

In this type of sliding nozzle apparatus, it is assumed that a surface pressure is loaded through the sliding metal frame in a state in which two refractory plates are mounted, respectively, to the fixed metal frame and the sliding metal frame. Thus, if a surface pressure is loaded to the sliding metal frame in a state in which no refractory plate is mounted due to a wrong operation of an operator or the like, the sliding metal frame itself, and/or other components constituting the sliding nozzle apparatus, such as a hinge shaft for enabling the sliding metal frame to swing with respect to the fixed metal frame, and a coupling shaft for coupling the sliding metal frame to a drive device for sliding the sliding metal frame have been likely to be damaged.

### CITATION LIST

Patent Document 1: JP 2014-208380 A

### SUMMARY OF INVENTION

### Technical Problem

A technical problem to be solved by the present invention is to provide a sliding nozzle apparatus in which components constituting the sliding nozzle apparatus are less likely to be damaged even when a surface pressure is loaded with no refractory plate mounted.

### Solution to Technical Problem

According to one aspect of the present invention, the following sliding nozzle plate is provided.

A sliding nozzle apparatus comprising a fixed metal frame and a sliding metal frame which is slidably provided with respect to the fixed metal frame, each of the fixed metal frame and the sliding metal frame having a plate-receiving recess for mounting a refractory plate therein, wherein the sliding nozzle apparatus is configured to load a surface pressure between a refractory plate mounted in the plate-receiving recess of the fixed metal frame and a refractory plate mounted in the plate-receiving recess of the sliding metal frame, in a state in which the two refractory plates are opposed to each other, and wherein the sliding metal frame is movable between a first position where, in a state where two refractory plates are mounted, respectively, in the plate-receiving recess of the fixed metal frame and the plate-receiving recess of the sliding metal frame, the surface pressure can be loaded between the two refractory plates, and a second position where, in a state where no refractory plate is mounted to either the plate-receiving recess of the fixed metal frame or the plate-receiving recess of the sliding metal frame, a surface pressure can be loaded between the fixed metal frame and the sliding metal frame.

### Advantageous Effects of Invention

According to the present invention, components constituting a sliding nozzle apparatus are less likely to be damaged even when a surface pressure is loaded with no refractory plate mounted.

### BRIEF DESCRIPTION OF DRAWINGS

FIGS. 1A and 1B are perspective views of a sliding nozzle apparatus which is one embodiment of the present invention, wherein FIG. 1A shows a state in which a sliding metal frame is slightly opened with respect to a fixed metal frame, and FIG. 1B shows a state in which the sliding metal frame is fully opened with respect to the fixed metal frame.

FIG. 2 is a front view of the sliding nozzle apparatus set in a horizontal state which is a usage state.

FIG. 3 is a top plan view of the sliding nozzle apparatus set in the horizontal state which is the usage state.

FIG. 4 is a bottom view of the sliding nozzle apparatus set in the horizontal state which is the usage state.

FIG. 5 is a sectional view taken along the direction A-A of FIG. 3.

FIG. 6 is a sectional view taken along the direction B-B of FIG. 3.

FIG. 7 is a sectional view taken along the direction C-C of FIG. 3.

FIG. 8 is a sectional view corresponding to FIG. 5, which shows a state in which no refractory plate is mounted to either the fixed metal frame or the sliding metal frame, and a surface pressure is loaded between the fixed metal frame and the sliding metal frame.

FIG. 9 is a sectional view corresponding to FIG. 6, which shows the state in which no refractory plate is mounted to either the fixed metal frame or the sliding metal frame, and a surface pressure is loaded between the fixed metal frame and the sliding metal frame.

FIG. 10 is a sectional view corresponding to FIG. 7, which shows the state in which no refractory plate is mounted to either the fixed metal frame or the sliding metal frame, and a surface pressure is loaded between the fixed metal frame and the sliding metal frame.

### DESCRIPTION OF EMBODIMENTS

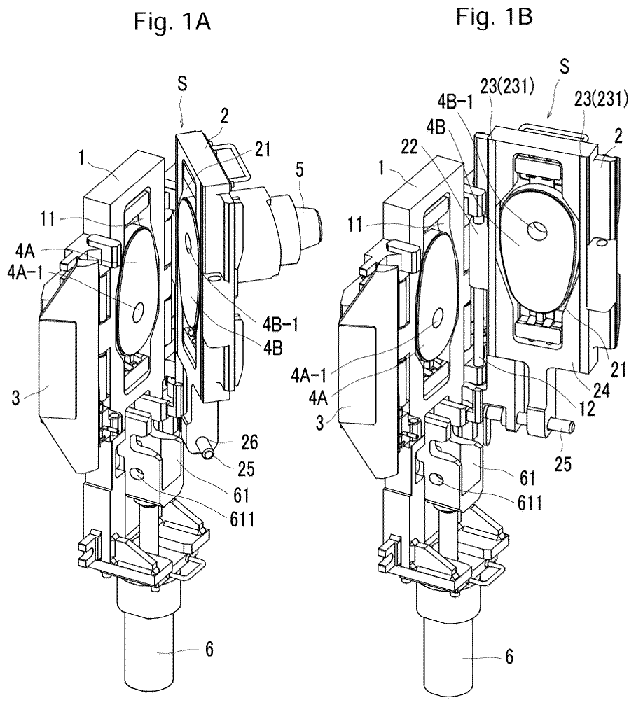

FIGS. 1A and 1B are perspective views showing a sliding nozzle apparatus according to one embodiment of the present inventio, wherein FIG. 1A illustrates a state in which a sliding metal frame is slightly opened with respect to a fixed metal frame, and FIG. 1B illustrates a state in which the sliding metal frame is fully opened with respect to the fixed metal frame. It should be noted here that, since the opening the slide metal frame is performed in a state in which the sliding nozzle apparatus is disposed to stand vertically, FIGS. 1A and 1B show the sliding nozzle apparatus in the state in which it is disposed to stand vertically.

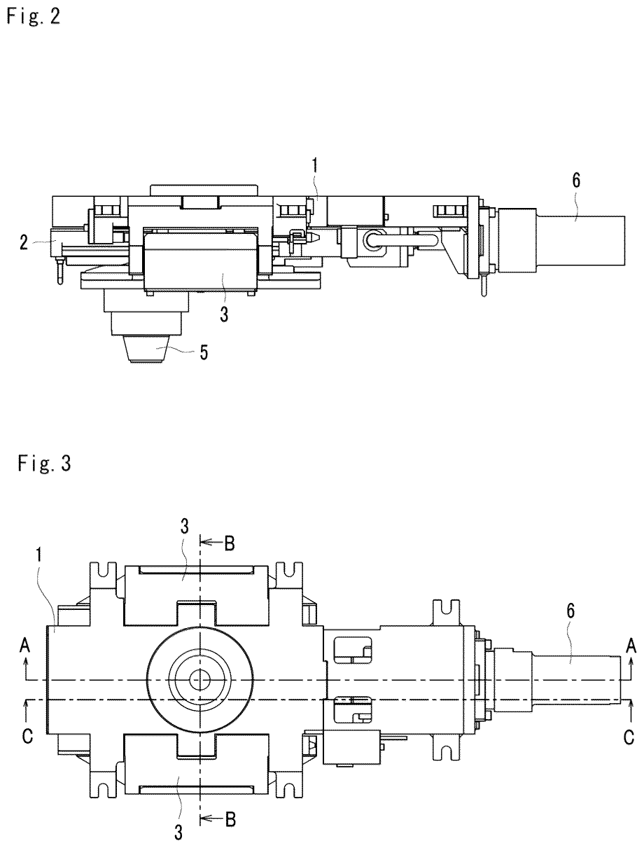

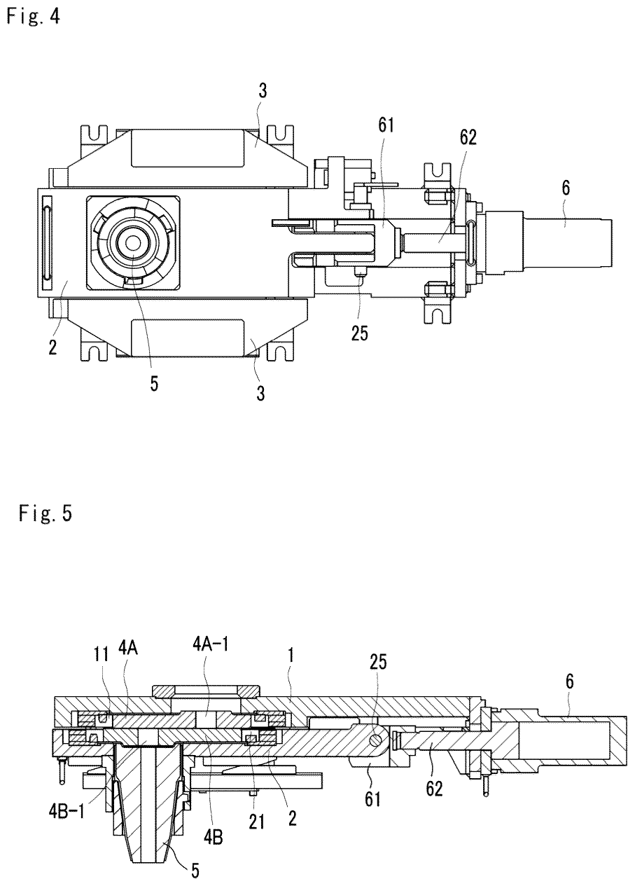

On the other hand, FIG. 2, FIG. 3 and FIG. 4 are, respectively, a front view, a top plan view, and a bottom view, showing a state in which the sliding nozzle apparatus is in a horizontal state, i.e., in a usage state. FIG. 5 is a sectional view taken along the direction A-A of FIG. 3.

The term “usage state” herein means a state in which a sliding nozzle apparatus is attached to the bottom of a molten metal vessel such as a ladle, and is adjusting the amount of outflow of molten steel during casting operation.

The sliding nozzle apparatus S according to this embodiment comprises: a fixed metal frame 1; a sliding metal frame 2 provided in a slidably and openable-closeable manner with respect to the fixed metal frame 1; and two spring boxes 3 swingably provided on both sides of the fixed metal frame 1, respectively.

The fixed metal frame 1 is an approximately rectangular plate-shaped member, and is formed with a plate-receiving recess 11 for receiving therein a refractory plate 4A. The fixed metal frame 1 is fixed to the bottom of a molten metal vessel such as a ladle, with a bolt (not illustrated).

The sliding metal frame 2 is also an approximately rectangular plate-shaped member, and is formed with a plate-receiving recess 21 for receiving therein a refractory plate 4B.

As appearing in FIG. 5, in the sliding nozzle apparatus S in the usage state, a surface pressure is loaded between the refractory plate 4A mounted in the plate-receiving recess 11 of the fixed metal frame 1 and the refractory plate 4B mounted in the plate-receiving recess 21 of the sliding metal frame 2 in a state in which the refractory plate 4A and the refractory plate 4B are opposed to each other, and the amount of molten steel flowing out of the molten metal vessel is adjusted by sliding the sliding metal frame 4. More specifically, a nozzle hole 4A-1 and a nozzle hole 4B-1 are provided, respectively, in the refractory plate 4A and the refractory plate 4B, and the degree of nozzle-hole opening formed by the overlap of the nozzle hole 4A-1 and the nozzle hole 4B-1 is changed by sliding the sliding metal frame 2, thereby adjusting the amount of the molten steel flowing out of the molten metal vessel. FIG. 5 shows a state in which the degree of nozzle-hole opening is fully closed. Further, a lower nozzle 5 is joined to the refractory plate 4B.

In this embodiment, the loading of a surface pressure is performed using the two spring boxes 3. Specifically, the sliding nozzle apparatus S of this embodiment equipped with the two spring boxes 3 can load or unload a surface pressure between/from between the refractory plate 4A mounted in the plate-receiving recess 11 of the fixed metal frame 1 and the refractory plate 4B mounted in the plate-receiving recess 21 of the sliding metal frame 2 in a state in which the refractory plate 4A and the refractory plate 4B are opposed to each other. A mechanism for loading or releasing the surface pressure by the two spring boxes 3 is well known, and thus description thereof will be omitted.

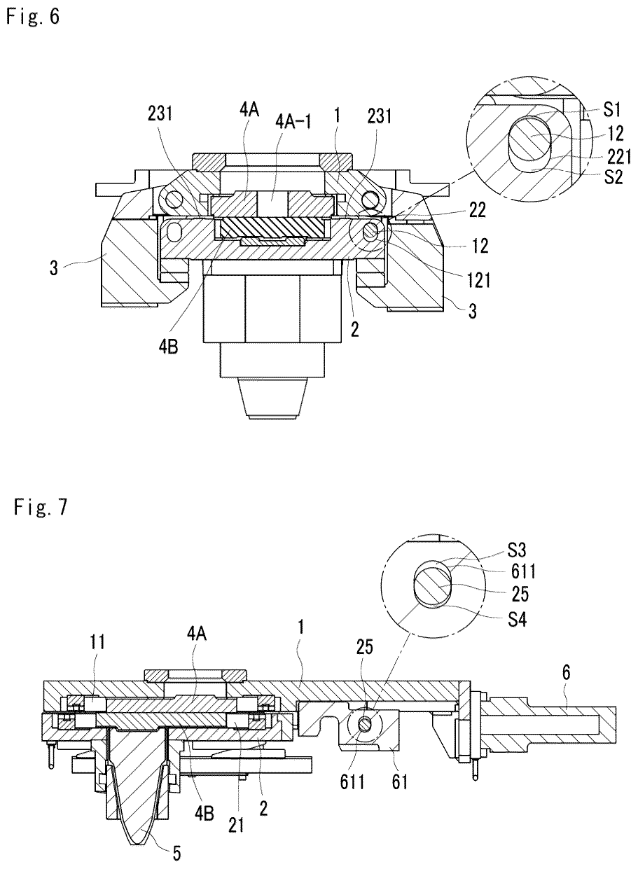

As appearing in FIG. 1B, the fixed metal frame 1 is provided with a hinge shaft 12 which supports a hinge 22 of the sliding metal frame 2 in a swingable and slidable manner. Further, as appearing in FIG. 6 which is an enlarged sectional view taken along the direction B-B of FIG. 3, the hinge 22 is provided with an elongate hole 221, and the hinge shaft 12 is inserted through the elongate hole 121. Specifically, in this embodiment, the sliding metal frame 2 is configured to be swung about a swinging axis defined by the hinge shaft 12 inserted through the elongate hole 221 of the hinge 22, so that it can be opened and closed with respect to the fixed metal frame 1. Further, in this embodiment, the sliding metal frame 2 is configured to be slid along the hinge shaft 12 inserted through the elongate hole 221 of the hinge 22, so that it can be slid with respect to the fixed metal frame 1. In this embodiment, the elongate hole 121 is formed elongate in a direction perpendicular to a sliding plane of the sliding metal frame 2.

As appearing in FIG. 1B, the sliding metal frame 2 is provided with two ridges 23 each extending in a sliding direction of the sliding metal frame 2 over the entire length of a respective one of opposed lateral edges of the sliding metal frame 2, wherein a top surface of each of the ridges 23 is formed as a convex surface 231. A surface on the inner side of the ridges 23 (on the center side of the sliding metal frame 2) is formed as a concave surface 24.

The sliding nozzle apparatus S comprises a drive device 6 for sliding the sliding metal frame. In this embodiment, a hydraulic cylinder is used as the drive device 6.

As appearing in FIGS. 1A and 1B, FIG. 4, FIG. 5, and FIG. 7 which is a sectional view taken along the direction C-C of FIG. 3, the drive device 6 comprises a coupling part 61 configured to be coupled with a coupling shaft 25 of the sliding metal frame 2. The coupling shaft 25 is attached, in an insertable and pullable manner, to a mounting hole 26 provided at a base end of the sliding metal frame 2. On the other hand, the coupling part 61 is fixed to a distal end of a drive shaft 62 of the drive device 6, and is provided with an elongate hole 611 through which the coupling shaft 25 is inserted so as to allow the coupling part 61 to be coupled with the coupling shaft 25. Specifically, in this embodiment, when the coupling shaft 25 is inserted through the mounting hole 26 and the elongate hole 611, the sliding metal frame 2 and the coupling part 61 of the drive device 6 are coupled together, so that the sliding metal frame 2 is slid by moving the drive shaft 62 of the drive device 6 forwardly and backwardly. In this embodiment, the elongate hole 611 is formed elongate in a direction perpendicular to the sliding plane of the sliding metal frame 2.

FIGS. 2 to 7 illustrates a state in which the refractory plate 4A and the refractory plate 4B are mounted, respectively, in the plate-receiving recess 11 of the fixed metal frame 1 and the plate-receiving recess 21 of the sliding metal frame 2, and the surface pressure is loaded between the refractory plates 4A, 4B. In other words, the sliding metal frame 2 is in a first position where, in a state in which the refractory plate 4A and the refractory plate 4B are mounted, respectively, in the plate-receiving recess 11 of the fixed metal frame 1 and the plate-receiving recess 21 of the sliding metal frame 2, a surface pressure can be loaded between the refractory plates 4A, 4B. Specifically, in this embodiment, as appearing in FIG. 6, the hinge shaft 21 of the fixed metal frame 1 is located on one side in an elongate direction (upper side in FIG. 6) of the elongate hole 221 provided in the hinge 22 of the sliding metal frame 2. More specifically, in FIG. 6, there is a gap S1 between an upper edge of the hinge shaft 12 and an upper edge of the elongate hole 221, and there is a gap S2 between a lower edge of the hinge shaft 12 and a lower edge of the elongate hole 221. In the first position, the length of the gap S1 in an up-down direction is less than the length the gap S2 in the up-down direction.

Further, as appearing in FIG. 7, the coupling shaft 25 of the sliding metal frame 2 is located on the other side in an elongate direction (lower side in FIG. 7) of the elongate hole 611 provided in the coupling part 61 of the drive device 6. Specifically, in FIG. 7, there is a gap S3 between an upper edge of the coupling shaft 25 and an upper edge of the elongate hole 611, and there is a gap S4 between a lower edge of the coupling shaft 25 and a lower edge of the elongate hole 611. In the first position, the length of the gap S3 in the up-down direction is greater than the length the gap S4 in the up-down direction.

Further, as appearing in FIG. 6, when the sliding metal frame 2 is in the first position, the convex surfaces 231 of the sliding metal frame 2 is not in contact with the fixed metal frame 1.

On the other hand, in this embodiment, the sliding metal frame 2 can be moved to a second position where, in a state in which neither the refractory plate 4 A nor the refractory plate 4 B is mounted in the plate-receiving recess 11 of the fixed metal frame 1 or the plate-receiving recess 21 of the sliding metal frame 2, a surface pressure can be loaded between the fixed metal frame 1 and the sliding metal frame 2. This will be specifically described below.

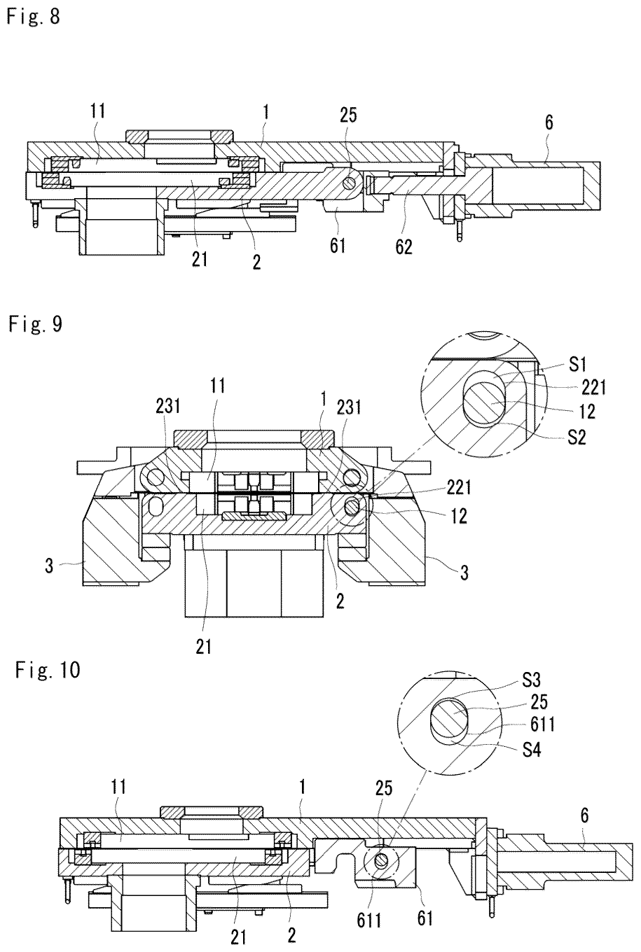

FIGS. 8 to 10 are sectional views corresponding to FIGS. 5 to 7, respectively, which show a state in which neither the refractory plate 4A nor the refractory plate 4B is mounted in the plate-receiving recess 11 of the fixed metal frame 1 or the plate-receiving recess 21 of the sliding metal frame 2, and the surface pressure is loaded between the fixed metal frame 1 and the sliding metal frame 2.

In the state illustrated in FIGS. 8 to 10, as appearing in FIG. 9, the hinge shaft 12 of the fixed metal frame 1 has been moved to the other side in the elongate direction (lower side in FIG. 9) of the elongate hole 221 provided in the hinge 22 of the sliding metal frame 2. Specifically, in FIG. 9, there is a gap S1 between the upper edge of the hinge shaft 12 and the upper edge of the elongate hole 221, and there is a gap S2 between the lower edge of the hinge shaft 12 and the lower edge of the elongate hole 221. In the second position, the length of the gap S1 in the up-down direction is greater than the length of the gap S2 in the up-down direction.

Further, as appearing in FIG. 10, the coupling shaft 25 of the sliding metal frame 2 is moved to one side in the elongate direction (upper side in FIG. 10) in the elongate hole 611 provided in the coupling part 61 of the drive device 6. Specifically, in FIG. 10, there is a gap S3 between the upper edge of the coupling shaft 25 and the upper edge of the elongate hole 611, and there is a gap S4 between the lower edge of the connecting shaft 22 and the lower edge of the elongate hole 611. In the second position, the length of the gap S3 in the up-down direction is less than the length of the gap S4 in the up-down direction.

Further, as appearing in FIG. 9, when the sliding metal frame 2 is in the second position, the convex surfaces 231 of the sliding metal frame 2 are in contact with the fixed metal frame 1, and the surface pressure is loaded between the fixed metal frame 1 and the sliding metal frame 2.

That is, the second position is a position where the surface pressure can be loaded between the fixed metal frame and the sliding metal frame. More specifically, the second position is a position where the sliding metal frame becomes parallel to the fixed metal frame, and the fixed metal frame and the sliding metal frame are brought in contact with each other.

As above, in this embodiment, the sliding metal frame 2 is movable between a first position where, in a state in which the refractory plate 4A and the refractory plate 4B are mounted, respectively, in the plate-receiving recess 11 of the fixed metal frame 1 and the plate-receiving recess 21 of the sliding metal frame 2, a surface pressure can be loaded between the refractory plates 4A, 4B, as shown in FIGS. 5 to 7, and a second position where, in a state in which neither the refractory plate 4A nor the refractory plate 4B is mounted in the plate-receiving recess 11 of the fixed metal frame 1 or the plate-receiving recess 21 of the sliding metal frame 2, a surface pressure can be loaded between the fixed metal frame 1 and the sliding metal frame 2, as shown in FIGS. 8 to 10. Specifically, in this embodiment, during the movement of the sliding metal frame 2 between the first position illustrated in FIG. 6 and the second position illustrated in FIG. 9, the hinge shaft 12 of the fixed metal frame 1 moves within the elongate hole 221 provided in the hinge 22 of the sliding metal frame 2. It should be noted that a member to be actually moved is not the hinge shaft 12 but the elongate hole 221, i.e., along with the movement of the elongate hole 221, the hinge shaft 12 relatively move within in the elongate hole 221. On the other hand, during the movement of the sliding metal frame 2 between the first position illustrated in FIG. 7 and the second position illustrated in FIG. 10, the coupling shaft 25 of the sliding metal frame 2 is moved within the elongate hole 611 provided in the coupling part 61 of the drive device 6.

Here, a conventional sliding nozzle apparatus is on the premise that, in a state in which two refractory plates are mounted, respectively, to a fixed metal frame and a sliding metal frame, loading or unloading of a surface pressure is performed with respect to the refractory plates, and loading of the surface pressure has been performed in a state in which the refractory plates mounted in respective plate-receiving recesses of the fixed and sliding metal frames are in surface contact with each other. Specifically, the conventional sliding nozzle apparatus has been configured such that the thickness of the refractory plate is greater than the thickness of the plate-receiving recess of each of the fixed and sliding metal frames, and the loading or unloading of the surface pressure is performed with respect to the refractory plates in a state in which the fixed metal frame and the sliding metal frame are not in contact with each other. In this case, with a view to coping with the movement of the sliding metal frame due to increase or decrease in pressure applied between the refractory plates, the conventional sliding nozzle apparatus also has been configured such that an elongate hole is provided in the hinge of the sliding metal frame, and a hinge shaft of the fixed metal frame is inserted through the elongate hole. On the other hand, the conventional sliding nozzle apparatus has been configured such that, when no refractory plate is mounted, the hinge of the sliding metal frame moves toward the fixed metal frame by a part of the thicknesses of the refractory plates, and thus a lower edge of the elongate hole of the hinge of the sliding metal frame and a lower edge of the hinge shaft of the fixed metal frame is brought into contact with each other. Thus, when the pressure is applied between the metal frames in this state, the hinge shaft is pressed toward the fixed metal frame by the lower edge of the elongate hole, leading to the possibility of bending of the hinge shaft.

More specifically, in the conventional sliding nozzle apparatus, when a surface pressure is loaded between the fixed metal frame and the sliding metal frame with no refractory plate mounted, the lower edge of the elongate hole of the hinge of the sliding metal frame is brought in contact with the lower edge of the hinge shaft of the fixed metal frame, and simultaneously an upper edge of a coupling shaft of the sliding metal frame is brought in contact with an upper edge of an elongate hole provided in a coupling part of a drive device. That is, in the conventional sliding nozzle apparatus, the sliding metal frame is not configured to be movable to a second position where a surface pressure can be loaded between the fixed metal frame and the sliding metal frame with no refractory plate mounted. In other words, in the conventional sliding nozzle apparatus, if a surface pressure is applied with no refractory plate mounted, components constituting the sliding nozzle apparatus, such as the hinge shaft and the coupling shaft, will be damaged.

In contrast, under problem recognition that a surface pressure can be loaded to the sliding metal frame in a state in which no refractory plate is mounted due to a wrong operation of an operator or the like, as mentioned above, the present invention addresses a technical problem of providing a sliding nozzle apparatus in which components constituting the sliding nozzle apparatus are less likely to be damaged even when a surface pressure is applied with no refractory plate mounted. In order to solve this technical problem, in this embodiment, the elongate-directional length of the elongate hole 221 provided in the hinge 22 of the sliding metal frame 2 is set to be greater than that of the elongate hole in the conventional sliding nozzle apparatus, such that the hinge shaft 12 of the fixed metal frame 1 can move within the elongate hole 221 between the first position illustrated in FIG. 6 and the second position illustrated in FIG. 9. Specifically, the elongate-directional length of the elongate hole 121 is set to be greater than that of the elongate hole in the conventional sliding nozzle apparatus in a direction away from the fixed metal frame 1 (in the down direction in FIG. 9), such that the gap S2 can be formed between the lower edge of the hinge shaft 12 and the lower edge of the elongate hole 221 in the second position illustrated in FIG. 9. Further, the elongate-directional length of the elongate hole 611 provided in the coupling part 61 of the drive device 6 is set to be greater than that of the elongate hole in the conventional sliding nozzle apparatus, such that the coupling shaft 25 of the sliding metal frame 2 can move within the elongate hole 611 between the first position illustrated in FIG. 7 and the second position illustrated in FIG. 10. Specifically, the elongate-directional length of the elongate hole 611 is set to be greater than that of the elongate hole in the conventional sliding nozzle apparatus in a direction closer to the fixed metal frame 1 (in the up direction in FIG. 10), such that the gap S3 can be formed between the upper edge of the coupling shaft 25 and the upper edge of the elongate hole 611 at the second position illustrated in FIG. 10.

As above, in this embodiment, the hinge shaft 12 is not brought into contact with the upper edge or lower edge of the elongate hole 221 even when the sliding metal frame 2 is in either of the first position and the second position, and the coupling shaft 25 is not brought in contact with the upper edge or lower edge of the elongate hole 611.

As described above, the sliding metal frame 2 is movable between the first position where, in the state where the refractory plates 4A, 4B are mounted, respectively, in the plate-receiving recess 11 of the fixed metal frame 1 and the plate-receiving recess 21 of the sliding metal frame 2, the surface pressure can be loaded between the refractory plates 4A, 4B, and the second position where, in the state in which neither the refractory plate 4A nor the refractory plate 4B is mounted to the plate-receiving recess 11 of the fixed metal frame 1 or the plate-receiving recess 21 of the sliding metal frame 2, a surface pressure can be loaded between the fixed metal frame 1 and the sliding metal frame 2. Therefore, in the sliding nozzle apparatus S of this embodiment, even when the surface pressure is applied in a state in which neither the refractory plate 4A nor the refractory plate 4B is mounted, components constituting the sliding nozzle apparatus S are less likely to be damaged.

Further, in this embodiment, the convex surface 231 and the concave surface 24 are provided in an edge region of the sliding metal frame 2, and the convex surface 231 is in contact with the fixed metal frame 1 when the sliding metal frame 2 is in the second position. In this way, a surface of the sliding metal frame 2 to be in contact with the fixed metal frame 1 when the sliding metal frame 2 is in the second position is limited to the convex surface 231, so that the surface pressure can be stably loaded between the fixed metal frame 1 and the sliding metal frame 2. Thus, the fixed metal frame 1 and the sliding metal frame 2 are less likely to be damaged when the surface pressure is loaded

Further, in this embodiment, even when the surface pressure is loaded in a state in which neither the refractory plate 4A nor the refractory plate 4B is mounted, components constituting the sliding nozzle apparatus S are less likely to be damaged, and thus the surface pressure can be loaded in the state in which neither the refractory plate 4A nor the refractory plate 4B is mounted. Thus, in the state in which neither the refractory plate 4A nor the refractory plate 4B is mounted, the degree of opening of the nozzle hole can be set in a fully open state, so that it becomes possible to clean an upper nozzle (illustration is omitted) above the fixed metal frame 1, without opening the sliding metal frame. Further, when a molten metal vessel such as a ladle is in an upright state, the degree of opening of the nozzle hole can be set in the fully opened state with no refractory plate mounted, so that brick waste fractions after dismantling lining bricks of the molten metal container can be discharged from the nozzle hole, or opening, of the sliding nozzle apparatus S.

### LIST OF REFERENCE SIGNS

S: sliding nozzle apparatus
1: fixed metal frame
11: plate-receiving recess
12: hinge shaft
2: sliding metal frame
21: plate-receiving recess
22: hinge
221: elongate hole
23: ridge
231: convex surface
24: concave surface
25: coupling shaft
26: mounting hole
3: spring box
4A, 4B: refractory plate
4A-1, 4B-1: nozzle hole
5: lower nozzle
6: drive device
61: coupling part
611: elongate hole
62: drive shaft

1. A sliding nozzle apparatus comprising a fixed metal frame and a sliding metal frame which is slidably provided with respect to the fixed metal frame, each of the fixed metal frame and the sliding metal frame having a plate-receiving recess for mounting a refractory plate therein,
wherein the sliding nozzle apparatus is configured to load a surface pressure between a refractory plate mounted in the plate-receiving recess of the fixed metal frame and a refractory plate mounted in the plate-receiving recess of the sliding metal frame, in a state in which the two refractory plates are opposed to each other,
and wherein the sliding metal frame is movable between a first position where, in a state where two refractory plates are mounted, respectively, in the plate-receiving recess of the fixed metal frame and the plate-receiving recess of the sliding metal frame, the surface pressure can be loaded between the two refractory plates, and a second position where, in a state where no refractory plate is mounted to either the plate-receiving recess of the fixed metal frame or the plate-receiving recess of the sliding metal frame, a surface pressure can be loaded between the fixed metal frame and the sliding metal frame.

2. The sliding nozzle apparatus as claimed in claim 1, wherein the sliding metal frame has a convex surface provided along an edge thereof, the convex surface being in contact with the fixed metal frame when the sliding metal frame is in the second position.

3. The sliding nozzle apparatus as claimed in claim 1, wherein the fixed metal frame is provided with a hinge shaft supporting a hinge of the sliding metal frame in a swingable and slidable manner, wherein the hinge shaft is inserted through the hinge, such that it is movable inside the hinge during movement of the sliding metal frame between the first position and the second position.

4. The sliding nozzle apparatus as claimed in claim 1, further comprising a drive device for sliding the sliding metal frame, the drive device comprising a coupling part coupled with a coupling shaft of the sliding metal frame, wherein the coupling shaft is movable inside the coupling part during movement of the sliding metal frame between the first position and the second position.

5. The sliding nozzle apparatus as claimed in claim 2, further comprising a drive device for sliding the sliding metal frame, the drive device comprising a coupling part coupled with a coupling shaft of the sliding metal frame, wherein the coupling shaft is movable inside the coupling part during movement of the sliding metal frame between the first position and the second position.

6. The sliding nozzle apparatus as claimed in claim 3, further comprising a drive device for sliding the sliding metal frame, the drive device comprising a coupling part coupled with a coupling shaft of the sliding metal frame, wherein the coupling shaft is movable inside the coupling part during movement of the sliding metal frame between the first position and the second position.

7. The sliding nozzle apparatus as claimed in claim 2, wherein the fixed metal frame is provided with a hinge shaft supporting a hinge of the sliding metal frame in a swingable and slidable manner, wherein the hinge shaft is inserted through the hinge, such that it is movable inside the hinge during movement of the sliding metal frame between the first position and the second position.

8. The sliding nozzle apparatus as claimed in claim 7, further comprising a drive device for sliding the sliding metal frame, the drive device comprising a coupling part coupled with a coupling shaft of the sliding metal frame, wherein the coupling shaft is movable inside the coupling part during movement of the sliding metal frame between the first position and the second position.
